(19) United States
(12) Patent Application Publication
(10) Pub. No.: US 2009/0204435 A1
(43) Pub. Date: Aug. 13, 2009

(54) SYSTEM FOR AUTOMATING MEDICAL IMAGING DIAGNOSTIC SERVICE DELIVERY

(76) Inventor: Brian Gale, Bronx, NY (US)

Correspondence Address: TED SABETY, c/o Sabety +associates, PLLC, 1130 Bedford Rd., PLEASANTVILLE, NY, 10570, US

(21) Appl. No.: 12/361,081

(22) Filed: Jan. 28, 2009

Related U.S. Application Data
(60) Provisional application No. 61/025,300, filed on Jan. 31, 2008.

(51) Int. Cl. G06Q 50/00; G06F 17/00; G06Q 40/00

(52) U.S. Cl. 705/3; 715/231; 705/2; 705/4; 705/400

(57) ABSTRACT

A system and method of automatically assigning diagnostic imaging centers, uploading diagnostic data, selecting and routing data to electronically connected reviewing physicians, on-line report generation and automatic billing is presented.

This application claims priority to and hereby incorporates by reference provisional patent application U.S. Pat. App. No. 61/025,300 filed Jan. 31, 2008, as a continuation.

### BACKGROUND OF THE INVENTION

The increase in volume and costs of medical diagnostic imaging testing calls for an automated system and method of managing the process of assigning patients to diagnostic imaging centers, processing the review of the results and presenting reports to the referring physician. Automating the process and permitting it to be conducted electronically permits greater efficiencies in terms of the allocation of resources and the processing of data. In addition, automating the billing and insurance reimbursement process will also save costs.

### SUMMARY OF THE INVENTION

This system is an ASP (Application Service Provider) designed to manage Screening Computed Axial Tomography Virtual Colonoscopy (SCTVC) exams and any other diagnostic imaging exams. SCTVC exams are specialized CAT scans which are obtained in order to screen for colon cancer. The images are processed and displayed using specialized software in order to simulate the view of optical colonoscopy. The system manages the process of having such images created, reviewed and reported on and delivery of such reports to the referring physician, as well as managing the billing for such procedures.

### BRIEF DESCRIPTION OF THE DRAWINGS

FIG. 1 presents the typical system architecture.

### DETAILED DESCRIPTION OF THE PREFERRED EMBODIMENTS

In one embodiment of the invention, a computer system will include a public website section. This portion of the web site will include these features:
Educational materials on SCTVC exams
Profiles of the physicians supervising and interpreting the exams.
Online registration
Appointment booking
Automated appointment reminders
Links and contact information for operations (i.e. appointments, billing)

The ASP will also include functionality for managing SCTVC exams, including:
Interface with each acquiring modality or PACS (Picture Archive and Communication System) at each local imaging center
   Storage and archiving of the current and relevant prior exams.
   Secured remote access for interpreting physicians
   Remote exam interpretation functionality. This enables the interpreting radiologist to evaluate the exam.
   Remote report production, enabling the interpreting physician to produce written reports using voice recognition technology and send the report into the system.
   Report database, The system will store radiological findings and enable correlation with findings at optical colonoscopy and diagnostic pathology results.
   Report transmission. The system will insert the SCTVC report onto the practice letterhead and transmit the report to the referring clinician.
   Notice Transmission. The system ill transmit notie messages to a Critical Test Result Reporting system.

Message delivery confirmation. For critical test results, the system will send real time electronic notification of an abnormal report to the referring clinician. When the clinician retrieves the reports, the system will record documentation. If the referring physician does not retrieve the report, the system will send repeat message notifications. After a pre-defined interval, the system will contact one or more additional, pre-designated “back up” clinicians until the message is retrieved.

The system is typically comprised of several computers operatively connected over a computer network, which can include the Internet, but may include other data networks interconnecting the various components. A first server hosts a website, which provides a first user interface that can be accessed by a primary care physician (also called the referring physician) or their staff. In another embodiment, an additional computer hosts account access data for each of the system “roles” referring physician, patient, imaging center, and interpreting physician). At the first user interface, a request for a radiological study (or any other diagnostic test) is requested by inputting data into the system. Additionally, data associated with the location of the patient is input. The system then searches through its database of diagnostic centers that can apply to that diagnostic test and returns centers with availability that are geographically or otherwise logistically efficient for the patient to use. The operators of the system server can enter into a transaction with the diagnostic imaging center purchasing blocks of diagnostic time at a discount rate. Then, the operators can fill the diagnostic time using this system. Alternatively, the diagnostic centers can submit rates charged, and then the selection of diagnostic center can include the best price. In another embodiment, the diagnostic centers can bid on available diagnostic work that otherwise meets the selection criteria, much as discussed below with regard to the reviewing physicians.

Availability can include time availability, which can be uploaded from systems where such data is stored and updated by or for the diagnostic center. In another embodiment, the referring physician can input the request for the diagnostic test and instruct the patient to select a diagnostic imaging center. The patient can access another page on the user interface to review this list and make a selection. The selection process results in a reservation notice being sent to the selected diagnostic center. Notice can be either a data packet message, email, printed post card, telephone call or any other method of providing notice to the selected diagnostic center that a particular patient is scheduled for a test. The notice can include patient data, insurance data, physician data or other kinds of electronic medical records, or portions thereof, that are communicated to the diagnostic center. Alternatively, the notice can be limited to a serial number or other unique code associated with the transaction. In this embodiment, only the referring physician's computers can map the serial number to the patient's identity. In another embodiment, the referring physician can input the patient name, whereby the system keeps a database matching patient names and physicians with serial numbers. Duplicate patient names can have added unique information, for example, birth dates stored as well in order in order to ensure a unique mapping from serial numbers to patients. This data, being highly sensitive, is typically segregated from any other data.

Upon completion of the diagnostic test, the diagnostic center can upload data representing the results of the test to the server. This can include image data for x-rays or other radiological imagery, CAT, PET or other scans, or any other digital data representing a test result. This data is uploaded and stored with a cross reference to the patient and the specific diagnostic transaction, typically by means of the serial number. IN another embodiment, the images are stored at the diagnostic center or some other facility and a data referencing the location of where the images are stored is uploaded. Practioners of ordinary skill will recognize that either a data item may be transmitted or a data item providing an address where the data item is stored. In either case, the transmitted data represents the image, either literally or by address reference.

Once uploaded to the server, the system can then place the diagnostic transaction index as a list of diagnostic test results available for review by reviewing physicians. Subscribing reviewing physicians, who are appropriately credentialed to review the diagnostic results, can access the website via an additional user interface. This user interface presents the reviewing physician with the list of available diagnostic transactions. The physician can retrieve the diagnostic test result for a transaction by means of actuating the user interface in a manner typical in the art. In one embodiment, the physicians access the system through a typical Internet web-browser, preferably with a secure connection, for example, with SSL. The physician logs in, typically, by means of inputting a username and password. The system checks that the password matches the username and then if approved, presents a screen with a set of options. In the preferred embodiment, inputting any of the data that uniquely identifies the patient this will result in the diagnostic image corresponding to the patient in the form of a data file being downloaded to the reviewing physician's computer over the data network, so that such computer can render and display the image. Alternatively, the exam result may be viewed remotely via “thin client” interface. After reviewing the diagnostic imaging exam, the reviewing physician can then use the user interface of the system to open an additional interface module that permits the physician to draft a report. This user interface may include pull down or other interface tools to have automatically generated text created that expedites the production of the report. The particular automated text selections may be dependent on the type of imaging result the reviewing physician is examining. For example, a colonoscopy image will have different frequently used phraseology from those presented for a CAT scan of the brain. In another embodiment, the reviewing physician can draft the report on their computer, including by typing into a computer text that is uploaded as part of or all of the report to the server. The report generating interface may include voice recognition software which the interpreting physician can use to dictate the report. The report generating interface may include check boxes or other similar graphics that

When the report is complete, the system saves the report in its database and then issues a notice to the originating referring primary care physician. Notice can be by data packet message, email, printed postal matter, telephone call, text message or any other means. The primary care physician, when notified of the report, can access the primary care user interface and access the diagnostic data and the report, and further download these data items from the server to the physician's own computer system. Alternatively, the server can house all of the diagnostic reports for a set of patients and physicians. In other words, the system can transmit the report to the physician's own computer systems, or the system can have one server that is accessed by all of the participants in the transaction. Any part of the system can be segregated out in this way to operate on a separate server with appropriate communication protocols between the servers. Practitioners of ordinary skill will recognize that any of these architectural variations essentially operate the same way.

All of the storage, access authorizations and communications of patient data will be compliant with the data privacy regulations under the Health Insurance Portability and Accountability Act of 1996, P. L. 104-191 (HIPAA), 45 CFR §160 and §164, Apr. 17, 2003, which are hereby incorporated by reference. It will be protected by typical encryption techniques and protocols. The patient identity and social security numbers can be kept separated by means of having an additional data base that cross references patient identity with the patient diagnostic transaction ticket number. This cross reference can be stored local to the ASP server and used to retrieve past medical history from a regional health information organization (RHIO), should one become available. This system will prevent anyone else viewing the data from being able to identify the patient. Alternatively, the cross reference can be stored locally at the referring physician's computer system.

For example, when the primary care physician inputs a diagnostic request, a transaction ticket is created. By ticket, it is meant a data record that contains data specific to the transaction. The ticket can be updated to contain information including the location of the diagnostic test center, the identity of the reviewing physician, the ongoing progress of the entire transaction, fee data, insurance carrier information, policy number, and any other data associated with that specific test. That ticket can include a serial number that is used by the diagnostic center and the reviewing physician as a substitute to the patient's identity in order to mask the name, address and social security number of the patient. Data transmissions between the diagnostic center, the server, the referring physician and the reviewing physician can all have this identifier or number presented during communication protocols, or embedded in the transmitted data in order that the receiving systems can determine which diagnostic transaction the data transmission is associated with. Practitioners of ordinary skill will recognize that the data entries in the transaction ticket can be address pointers to the actual data rather than the data themselves, that is, an address pointer that tells a computer where to find the data representing the item, rather than carrying the data item itself. All references within the system can be by means of this transaction ticket or serial number. When the primary care physician accesses test results and reviews results, the system can locally translate diagnostic ticket numbers in the database to the actual patient name and address. This can be accomplished by a protocol whereby the system uploads patient data from a remote database under the control of the primary care physician at the time the physician logs in to access the user interface, and then deletes the data when the physician logs off. Alternatively, the data can be uploaded automatically or input by keystroke into a database housed on the remote server, but the data can be encrypted with a key held by or under the physician or the physician's practice administrators.

The system server can be connected through a data network to the primary care physician's computer in order that diagnostic requests be uploaded in a batch. The diagnostic centers can have computers containing scheduling information that is accessible by the system server. Alternatively, the patient can call the diagnostic center to independently schedule the test. In that embodiment, the diagnostic center will receive a transaction ticket authorizing the test that the patient is scheduling. The reviewing physicians typically will access the system through an Internet browser in order to view the tests. They can alternatively download the images or test data, and compose reports on remote computers, whereby such report data can be uploaded to the server. The selection of reviewing physician can occur as follows: a reviewing physician can simply log-in and see what review work is available. If certain reviews are subject to time deadlines, the presented work can be limited to the most urgent reviews, or the work presented in order of urgency. In addition, the available work can be limited to those subjects for which the reviewer is qualified. For example, a urinary tract review will not be presented to an orthopedic surgeon. In addition, an auction can be created whereby a reviewing physician can bid for the work. The work can then be assigned to the lowest bidder. The selection criteria may also be combined, such that the lowest cost relevant specialist is used. The typical system will be operated to pre-screen the qualifications of the registered reviewing physicians as well as the participating diagnostic medical centers. Pre-screening includes confirming the certifications held by the reviewing physicians, certifications and inspections conducted of the diagnostic medical centers, and the insurance status of both. The result of a pre-screening means that the reviewing physician is issued a unique login identity and password as well as appropriate contractual commitments on the part of the reviewing physician.

The website can present different user interfaces to the different users of the website by providing password protected access. The primary care physician, reviewing physician, patient and diagnostic center can each have identifiers and passwords that let each view one of four user interfaces, depending which class of user they are. Storage of patient data is accomplished in accordance with the HIPAA statute and regulations as well as any other data privacy law.

The system can also track billing by maintaining in the data base which diagnostic center performed a test as well as which reviewer reviewed the results. This data can be used to automatically formulate insurance reimbursement forms or similar documents for arranging insurance payment. The database can store different fees for different reviewing physicians and for different diagnostic imaging centers and for different imaging procedures. In another embodiment, the diagnostic center and the reviewing physician can update the transaction ticket to include their fees. Insurance reimbursement transactions can be automatically executed by the insurance carrier receiving data messages or email, or physically printed material automatically generated by the system, where the patient's insurance carrier and policy information is retrieved from the database and the charges from providing the diagnostic service are combined to automatically create a document that is a billing document that can be delivered to the insurance carrier, either electronically, or as a result of printing out the document and mailing it.

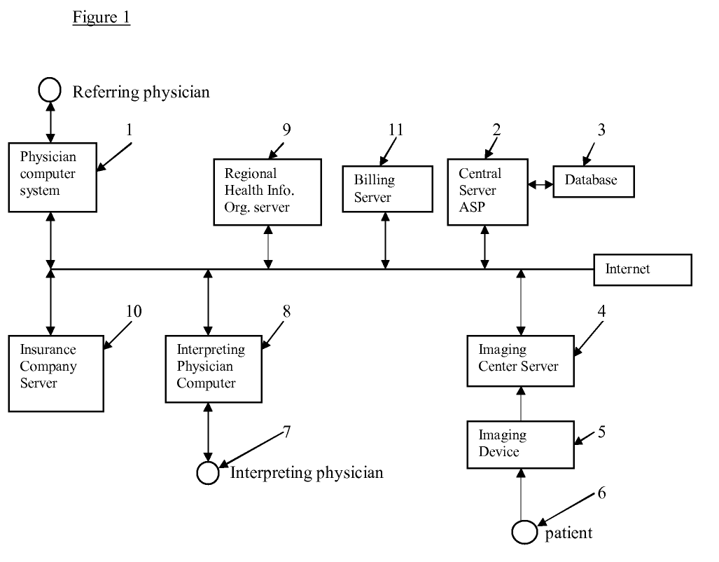

The system architecture of one embodiment is presented in FIG. 1. A referring physician (1) creates a data message and sends it to the ASP (application service provider) central server (2), which creates a data record for the transaction, or ticket, in the database (3). The ticket includes the geographic location selected by the referring physician, typically, a city or town where the patient resides or works. The ASP server searches its database (3) for a participating imaging center (4) with the appropriate imaging device (5) associated with the diagnostic test the referring physician seeks, where the imaging center (4) is closest to or meets some other similar selection criteria in relation to the patient (6). Selection criteria can include association with an insurance carrier coverage plan, cost, capability as well as geographic location. The referring physician can also override the automation and select a specific imaging center. The ASP server sends a transaction request to the Imaging Center server in order to authorize the test, which can include the appropriate patient information. The transaction request can be a data packet message, email or any other means of communication. This can also include scheduling data for the patient. The patient (6) is sent to the imaging center (4) where the imaging device (5) creates the appropriate diagnostic image, in digital form as digital data, which can include X-ray, CAT scan, PET scan, other kinds of tomography, colonoscopy, ultrasound or any other diagnostic test that creates a digital image or other diagnostic data that is to be interpreted by a physician. The diagnostic data created by the imaging device (5) is transmitted to the ASP server and stored in the database with the appropriate indicia of identity associating it with the transaction ticket. The ASP server can then select an interpreting physician to review the diagnostic data. This selection can be accomplished by presenting the transaction ticket in a list to all participating interpreting physicians when the log into the ASP system. The interpreting physician can then select a case presented on a web-page accessible only to the participating interpreting physician. Alternatively, the interpreting physicians can present bids to the ASP server (2) indicating how much of a fee would be charged for a specific case. The ASP server (2) can then select the interpreting physician with the lowest bid fee. After selection, the diagnostic data is transmitted to the interpreting physician computer (8) so that it may be rendered and displayed to the interpreting physician (7). The interpreting physician can then compose a report on the interpreting physician computer (8) or alternatively, log into the ASP server (2) and compose such a report on a web-page. The report is transmitted to (or in the latter case resides on) the ASP server and is stored in the database (3). A message is then transmitted to the referring physician computer (1) by means of email, data packet message, text message or any other means of communication. The referring physician can then retrieve the report and the diagnostic data from the ASP server (2) and download the report and data to the referring physician computer (1). The ASP server (2) can create from the transaction ticket an invoice for the either the patient (if the patient is self paying for the procedure) or the insurance carrier, associated with the transaction ticket, or the carrier's electronic billing clearing house and transmit the invoice by data packet message, email, fax, or any other means of communication, to the appropriate recipient (10), which can include the insurance carrier's incoming billing server or the insurance clearing house server. By “insurance clearing house”, it is meant a system whose function includes taking as input medical service invoices and determining which insurance carrier the invoice is for and routing the invoice to that carrier in some manner, including aggregating the invoices and processing payments. In another embodiement, the Regional Health Information Organization server (9) contains a database that translates the serial number associated with the transaction ticket with the patient data, including the patient name, address, social security number (or other identifier) and insurance plan. The ASP server (1) can request appropriate data from the RHIO server (9) in order to create the appropriate invoices for the insurance company server (10). Alternatively, the referring physician, or its associated practice management staff (1) can input this data into a web-page residing on the ASP server (2). Alternatively, the ASP server (2) can generate an invoice that is presented to the referring physician.

Practitioners of ordinary skill will recognize that the bill generation system can be segregated from the diagnostic database so that no single database contains patient diagnostic data and patient identification, other than the transaction ticket. The billing can be created using a separate server (11) containing a separate database where the transaction ticket is delivered, with the appropriate service fee and payee information, but no diagnostic report or diagnostic data. That billing system can then be interfaced with either the referring physician's systems (1), or present interactivity with the referring physician, or interface with the RHIO system (9) or a combination thereof, in order to create an invoice for the insurance carrier system (10). This alternative architecture protects the privacy of the patient because no one person can access both the billing system and the diagnostic system except for the referring physician.

In another embodiment, the system can operate with a client side program running on the referring physician's computer system (1). That software can interface with a database stored locally so that the physician can input locally the patient information and have that information stored locally. When a transaction is initiated, the client software running on the referring physician's computer (1) can communicate with the ASP server (2) and request a unique transaction ticket number. This number is retrieved and stored in the local database (1) to associate the patient information with the transaction ticket number. Then, the client software can transmit a diagnostic request to the ASP server (2) with only the transaction ticket number. Similarly, at the billing stage, the billing server (11) can request from the client software running on the referring physician's computer (1) the patient data required to be inserted in the invoice to the insurance company (10).

Communications between the systems can be encrypted to protect the data using typical encryption techniques well known in the art, including SSL (Secure Sockets Layer) and the like. Similarly, log-in procedures can include presenting a password unique to the referring physician or the interpreting physician or the imaging center. Practitioners of ordinary skill will recognize that password systems can include multiple passwords for each of these parties to address the fact that the referring physician may in fact be a large practice with multiple staff members. Practitioners of ordinary skill will recognize that known password protections include using biometric data of the user, for example, fingerprints, in order to access data.

A server may be a computer comprised of a central processing unit with a mass storage device and a network connection. In addition a server can include multiple of such computers connected together with a data network or other data transfer connection, or, multiple computers on a network with network accessed storage, in a manner that provides such functionality as a group. Practitioners of ordinary skill will recognize that functions that are accomplished on one server may be partitioned and accomplished on multiple servers that are operatively connected by a computer network by means of appropriate inter process communication. In this disclosure “computer system” is meant to include one or more computers and other devices that are operably connected by means of such inter-process communication, or other data exchange protocols and is not limited to a single computer. The computers comprising the computer system may be located physically proximate or geographically distributed.

In addition, the access of the website can be by means of an Internet browser accessing a secure or public page or by means of a client program running on a local computer that is connected over a computer network to the server. A data message and data upload or download can be delivered over the Internet using typical protocols, including TCP/IP, HTTP, SMTP, RPC, FTP or other kinds of data communication protocols that permit processes running on two remote computers to exchange information by means of digital network communication. As a result a data message can be a data packet transmitted from or received by a computer containing a destination network address, a destination process or application identifier, and data values that can be parsed at the destination computer located at the destination network address by the destination application in order that the relevant data values are extracted and used by the destination application. Data items that are transmitted may be transmitted in one or more data packets or as a continuous stream of data. The act of “transmitting” may encompass the transmission of one or more data packets in a series of transmissions. The act of “receiving” may be the receipt of one or more transmissions.

Practitioners of ordinary skill will recognize that the data entries in the data packet may be address pointers to the actual data rather than the data themselves, that is, a communication between processes may provide the receiving computer an address pointer that tells the computer where to find the data representing the item, rather than providing the data item itself. In this disclosure, the term “data representing” an item is meant to include either mechanism: that is, an address specifying a location where the data object is stored or may be obtained or the data object itself.

The spirit and scope of the present invention are to be limited only by the terms of the appended claims. It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The method described herein can be executed on a computer system, generally comprised of a central processing unit (CPU) that is operatively connected to a memory device, data input and output circuitry (IO) and computer data network communication circuitry. Computer code executed by the CPU can take data received by the data communication circuitry and store it in the memory device. In addition, the CPU can take data from the I/O circuitry and store it in the memory device. Further, the CPU can take data from a memory device and output it through the IO circuitry or the data communication circuitry. The data stored in memory may be further recalled from the memory device, further processed or modified by the CPU in the manner described herein and restored in the same memory device or a different memory device operatively connected to the CPU including by means of the data network circuitry. The memory device can be any kind of data storage circuit or magetic storage or optical device, including a hard disk, optical disk or solid state memory.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as FORTRAN, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form. The software logic components may, generally, be implemented in hardware as hardware logic circuits, if desired, using conventional techniques.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies, networking technologies, and internetworking technologies. The computer program may be distributed in any form as a removable storage medium with accompanying printed or electronic documentation (e.g., shrink wrapped software or a magnetic tape), preloaded with a computer system (e.g., on system ROM or fixed disk), or distributed by data transmission from a server or electronic bulletin board over a data communication network (e.g., the Internet or World Wide Web.)

The described embodiments of the invention are intended to be exemplary and numerous variations and modifications will be apparent to those skilled in the art. All such variations and modifications are intended to be within the scope of the present invention as defined in the appended claims. Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the figure is intended only to provide an extremely detailed disclosure of the present invention and is not intended to be limiting.

1. A method performed by a computer system comprising:
Receiving data representing a request for a diagnostic test for a patient from a first computer;
Transmitting data representing the identity of at least one diagnostic imaging center;
Receiving data representing a diagnostic image from a second computer, said diagnostic image a result of conducting the diagnostic test;
Transmitting the data representing a diagnostic image to a third computer;
Receiving from the third computer data representing a report regarding the diagnostic image;
Storing in a database the data representing the report.

2. The method of claim 1 further comprising:
Receiving data representing a selection of one of the at least one diagnostic imaging centers.

3. The method of claim 2 further comprising:
Transmitting at least one data representing available times to conduct a diagnostic test, such transmitted at least one data corresponding to the at least one diagnostic imaging center.

4. The method of claim 1 further comprising:
Selecting at least one diagnostic imaging center.

5. The method of claim 4 where the selection is made as a function of at least one of: geographic location, availability at a particular time, type of diagnostic test.

6. The method of claim 1 further comprising:
From a plurality of computers, selecting the third computer to receive the data representing the diagnostic image.

7. The method of claim 6 where the selection step is made as a function of at least one of: practice specialty, seniority, diagnostic credentials, fee charged, time availability.

8. The method of claim 1 further comprising:
Receiving data representing the identity of the patient's insurance carrier;
Generating data representing an invoice;
Transmitting the data representing the invoice to a fourth computer.

9. The method of claim 6 where the selection step is made as a function of the type of diagnostic test that was requested.

10. The method of claim 1 further comprising:
Transmitting to the third computer data representing a list of at least one element, said element a reference to at least one corresponding set of diagnostic images that are in need of a report.

11. The method of claim 10 where the list is presented in the order of urgency of said report.

12. The method of claim 1 further comprising:
Causing to be displayed on the third computer display device at least one pre- determined text phrase, each said at least one text phrase being associated with the type of diagnostic test.

13. The method of claim 1 where the received report is comprised of at least one pre-determined text phrase.

14. The method of claim 1 further comprising:
Transmitting to said third computer at least one predetermined text item selected from a plurality of predetermined text items, to be inserted into said report, said selection being made as a function of the type of diagnostic test requested.

15. The method of claim 1 further comprising:
Receiving from memory a plurality of data representing the fee to be charged for a report received from each of a plurality of candidate third computers;
Selecting from the plurality of candidate third computers a computer to operate as the third computer where the fee corresponding to said selected computer is the lowest of the plurality of received candidate fees.

16. The method of claim 1 further comprising:
Transmitting data representing notice to the physician referring the diagnostic test that the report has been received.

17. The method of claim 4 where the selection is a function of matching the identity of the insurance carrier of the patient with imaging centers that are authorized by the same insurance carrier.

18. The method of claim 4 where the selection step comprises:
Receiving from the first computer a first data representing the insurance carrier associated with the patient;
Retrieving from memory a second data representing the identity of at least one insurance carrier associated with the diagnostic imaging center.
Determining if the first data and second data substantially match.

19. The method of claim 8 where the fourth computer is operated on behalf of an insurance payment clearance service or an insurance carrier.

20. The method of claim 1 further comprising:
Transmitting to a fourth computer associated with an RHIO, data representing an indicia of identity of the patient and the type of test.

21. A method executed by a computer system comprising:
Transmitting data representing a request for a diagnostic test for a patient;
Receiving data representing the identity of at least one diagnostic imaging center;
Transmitting data representing the identity of one of the at least one diagnostic imaging centers.
Receiving data representing a notice that a report on the requested diagnostic test is available.

22. The method of claim 21 further comprising:
Receiving at least one data representing available times corresponding at least one diagnostic imaging center.

23. The method of claim 21 further comprising:
Receiving data representing a report on the requested diagnostic test.

24. The method of claim 1 further comprising:
Transmitting to a computer system operating as a critical test result management service data representing notice that the diagnostic report has been completed.

25. The method of claim 1 further comprising:
Receiving from memory a plurality of data representing the fee to be charged for conducting a diagnostic test received from each of a plurality of candidate second computers;
Selecting from the plurality of candidate second computers a computer to operate as the second computer where the fee corresponding to said selected computer is the lowest of the plurality of received candidate fees.

26. A computer system comprising at least one memory device containing program data, that when executed causes the computer system to execute the method of claim 1.

27. A computer readable medium, said medium comprised of data that when executed causes the computer system to execute the method of claim 1.
